(19) United States
(12) Patent Application Publication
(10) Pub. No.: US 2025/0083617 A1
(43) Pub. Date: Mar. 13, 2025

(54) SOUND PROTECTION SCREEN

(71) Applicant: TREVES PRODUCTS,SERVICES & INNOVATION, Paris (FR)

(72) Inventors: Alicia LECOMTE, Paris (FR); Eric DELINSELLE, Paris (FR)

(21) Appl. No.: 18/292,953

(22) PCT Filed: Jul. 28, 2022
(86) PCT No.: PCT/EP2022/071177

§ 371 Date: Jan. 29, 2024

(30) Foreign Application Priority Data
Jul. 29, 2021 (FR) FR2108253

(51) Int. Cl. B60R 13/08

(52) U.S. Cl. CPC B60R 13/0815

(57) ABSTRACT

The invention concerns a sound protection screen (1) intended to be mounted under a motor vehicle, comprising a thermo-compressed shell (2) based on structural fibers bonded together by a heat-activated bonding agent, and provided with an outer face (3) covered with a protective fibrous layer (4) consisting of: between 50% and 70% of bi-component fibers comprising a high-melting point core and a lower-melting point sheath; between 30% and 50% of polypropylene fibers, so as to present an apolar component conducive to low ice adhesion, said layer having been melted at a temperature higher than the melting temperature of said sheath and polypropylene and lower than that of said core, so as to provide a smoothed surface state and to minimize mechanical ice adhesion.

The invention relates to a sound protection screen intended to be mounted under a motor vehicle and to a method of producing such a screen.

It is known to produce a sound protection screen intended to be mounted under a motor vehicle, said screen comprising a thermo-compressed shell, said shell being based on structural fibers bonded together by a heat-activated bonding agent, said shell being provided with an outer face intended to face the road.

Thanks to the porosity of the shell, this type of screen has the advantage to allow acoustic absorption of engine noise.

However, over the course of its life, such a screen is subject to various surface aggressions, in particular:
adhesion of icicles which, when torn off, can lead to deterioration of the screen surface finish, thus by tearing off surface fibers,
scraping that may occur on the screen surface, e.g. when the vehicle hits a kerb, leading to surface damage.

To overcome these drawbacks, it has been proposed to cover the face exposed to the spatter with a film or a coating of plastic material.

However, the application of such a film or coating leads to a deterioration in absorption properties, insofar as said film creates on the screen a sealing barrier that prevents acoustic waves from propagating into it to be absorbed.

The aim of the invention is to overcome these disadvantages by offering a screen having a great robustness against the above-mentioned surface aggressions, while at the same time providing good sound absorption performance.

To this end, the invention proposes a sound protection screen intended to be mounted under a motor vehicle, said screen comprising a thermo-compressed shell, said shell being based on structural fibers bonded together by a heat-activated bonding agent, said shell being provided with an outer face intended to face the road, said screen further having the following characteristics:
it also includes a protective fibrous layer covering said outer face,
the fibers constituting said layer are of two types distributed according to the following percentages by weight:
   between 50% and 70% of bi-component fibers comprising a core with a high melting point and a sheath with a lower melting point, said sheath ensuring the bond between the fibers following its melting,
   between 30% and 50% of polypropylene fibers, so as to present an apolar component conducive to low ice adhesion on said layer,
said layer has been melted at a temperature higher than the melting temperature of said sheath and polypropylene and lower than that of said core, so as to provide a surface state smoothened by said melting and to minimize the mechanical adhesion of ice on said layer.

With such a layout:
the adhesion of icicles is minimized and their tear off does not damage the screen surface,
in addition, the screen has a great robustness against potential surface scraping.

In addition, as will be seen later, the sound absorption properties of the screen remain very similar to those of a screen without a protective layer.

According to another aspect, the invention proposes a method for making such a screen, which comprises the following steps:
provide a first fibrous web comprising structural fibers and a heat-activatable bonding agent,
provide a second fibrous web whose fibers are of two types distributed according to the following percentages by weight:
   between 50% and 70% of bi-component fibers comprising a core with a high melting point and a sheath with a lower melting point, said sheath ensuring the bond between the fibers following its melting,
   between 30% and 50% of polypropylene fibers,
superimpose said layers one on top of the other and compress the assembly between two platens heated to a temperature firstly higher than the melting temperature of said sheath and polypropylene and than the activation temperature of said bonding agent, and secondly lower than that of said core,
shape said assembly once heated in a cooled mold to give it the geometry of the screen to be obtained,
remove said screen.

Further features and advantages of the invention will become apparent from the following description, made with reference to the attached figures, in which:

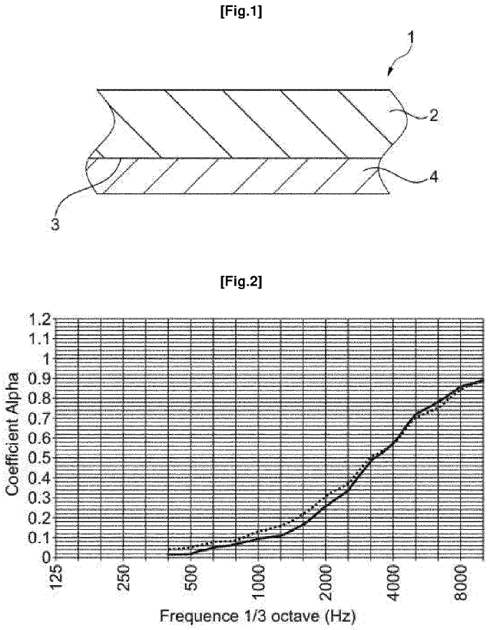

FIG. 1 is a schematic partial section view of a screen according to one embodiment,

FIG. 2 is a graphical representation of the sound absorption performance (alpha coefficient on the ordinate) as a function of ⅓-octave frequency in Hertz, in diffuse field, of a sample from a screen according to the invention (dashed curve) and of another sample from a reference screen (solid curve) according to the prior art (whose characteristics are presented below).

We now describe a sound protection screen 1 intended to be mounted under a motor vehicle—for example a screen under the engine, under the exhaust line or even arranged in any area under the bodywork, including in the mudguard area, said screen comprising a thermo-compressed shell 2, the said shell being based on structural fibres bonded together by a heat-activated bonding agent, said shell being provided with an outer face 3 intended to be turned towards the road, said screen also having the following characteristics:
it also includes a protective fibrous layer 4 covering said outer face,
the fibers constituting said layer are of two types distributed according to the following percentages by weight:
   between 50% and 70% of bi-component fibers comprising a core with a high melting point and a sheath with a lower melting point—for example between 11° and 180° C.—, said sheath ensuring the bond between the fibers following its melting,
   between 30% and 50% of polypropylene fibers—in particular with a melting point of the order of 160° C.—, so as to present an apolar component conducive to low ice adhesion on said layer,
said layer has been melted at a temperature higher than the melting temperature of said sheath and polypropylene and lower than that of said core, so as to provide a surface state smoothened by the said melting and minimize the mechanical adhesion of ice on the said layer.

In one embodiment, the resistance to passage of air of screen 1 is between 250 and 8000 N·s·m−3.

In one embodiment, the protective layer 4 is co-needled with the shell 2.

According to various embodiments, the bonding agent of the shell 2 is optionally formed:
of bi-component fibers whose sheath has been melted,
or of polypropylene fibers.

It is specified therein that bi-component fibers comprise a core with a high melting point and a sheath with a lower melting point, said sheath ensuring the bond between the fibers following its melting.

In particular, bi-component fibers comprise a core of polyethylene terephthalate, with a melting point of the order of 250° C., and a sheath of polyethylene terephthalate that was chemically modified to have a lowered melting point, for example of the order of 180° C.

In one embodiment, the shell 2 also comprises fine fibers with a titre of less than 3.5 dtex to improve sound absorption.

Various examples of compositions for shells 2 are presented hereinbelow.

According to a first example, the constituent fibres of the shell 2 are distributed according to the following percentages by weight:
between 15% and 25% of fine fibers based on polyethylene terephthalate (PET) with a titre of between 1.5 and 3.3 dtex,
between 30% and 40% of glass structural fibers, in particular with a diameter of between 20 and 30 microns,
between 40% and 50% of polypropylene bonding fibers ensuring a bond between the fibers of said shell following their fusion.

According to a second example, the constituent fibers of the shell 2 are distributed according to the following percentages by weight:
between 25% and 35% of fine fibers based on polyethylene terephthalate (PET) with a titre of between 1.5 and 3.3 dtex,
between 25% and 35% of polyethylene terephthalate (PET)-based structural fibers with a titre of between 6 and 7 dtex,
between 35% and 45% of bonding fibers, in particular of polypropylene or bi-component, ensuring a bond between the fibers of said shell following their at least partial fusion.

According to a third example, the constituent fibres of shell 2 are distributed according to the following percentages by weight:
between 15% and 25% of fine fibers based on polyethylene terephthalate (PET) with a titre of between 1.5 and 3.3 dtex,
between 30% and 40% of natural structural fibers (linen, hemp . . . ),
between 40% and 50% of polypropylene bonding fibers ensuring a bond between the fibers of said shell following their fusion.

A method of making such a screen 1 is now described, said method comprising the following steps:
provide a first fibrous web comprising structural fibers and a heat-activatable bonding agent,
provide a second fibrous web whose fibers are of two types distributed according to the following percentages by weight:
   between 50% and 70% of bi-component fibers comprising a core with a high melting point and a sheath with a lower melting point, said sheath ensuring the bond between the fibers following its melting,
   between 30% and 50% of polypropylene fibers,
superimpose said layers one on top of the other and compress the assembly between two platens heated to a temperature firstly higher than the melting temperature of said sheath and polypropylene and than the activation temperature of said bonding agent, and secondly lower than that of said core—the heating temperature being in particular comprised between 20° and 215° C.,
shape said assembly once heated in a cooled mold to give it the geometry of said screen to be obtained,
remove said screen.

In one embodiment, the method comprises an additional step of co-needling the fibrous webs together before compressing them between the platens.

In one embodiment, the bi-component fibers of the second web have a titre of between 2 and 5 dtex before the sheath melts.

In one embodiment, the polypropylene fibers of the second web have a titre of between 6 and 17 dtex before melting.

Finally, we present a comparison of the results obtained on a screen sample 1, according to one embodiment, compared with a reference screen sample, devoid of a protective layer 4 (therefore provided only with a shell 2), in tests of:
icicle detachment,
sidewalk passage,
sound absorption.

The sample according to the invention has:
a mass per unit area of 1000 g/m², the shell 2 representing 80% of the total mass and the protective layer 4 20% of said mass,
a thickness of 4 mm.

The reference sample has only a shell 2 and no protective layer 4.

In order to make relevant comparisons, the shell 2 of the reference sample is weighed down by the mass corresponding to the protective layer 4, so as to have the same mass per unit area (1000 g/m²) as the sample according to the invention. In addition, a reference sample of the same thickness (4 mm) as that of the sample according to the invention is provided.

As for the composition of the shell 2 of the reference sample, it is the same as that of the shell 2 of the sample according to the invention.

In other words, a sample according to the invention is compared to a reference sample with similar characteristics, using the three tests mentioned above.

The composition of the shell 2, in the reference sample and in the sample according to the invention, is as follows:
30% of fine polyethylene terephthalate (PET) fibers with a titre of 3.3 dtex,
30% of polyethylene terephthalate (PET)-based structural fibers with a titre of 6.7 dtex,
40% of polypropylene bonding fibers.

As for the protective layer 4 of the sample according to the invention which is being tested, it has the following composition:
60% of bi-component polyethylene terephthalate (PET) fibers,
40% of polypropylene fibers.

The icicle detachment test is carried out as follows for both samples, the reference sample and the sample according to the invention:
a 150×80 mm sample is placed at a temperature of −15+/−2° C. for 1 hour,
a hollow cylindrical template with an internal diameter of 44 mm is also placed at −15+/−2° C. for 1 hour,
the sample and the template are then placed on a support, with the protective layer 4 of the sample according to the invention facing said template, then 5 ml of water are poured into the template, then frozen at −15+/−2° C.; then again 5 ml of water are poured in; after 30 minutes, after checking that the 10 ml are frozen, 15 ml of water are poured into the template and left to stand at −15+/−2° C. for 150 minutes,
to perform the measure, a dynamometer is attached to the template while the sample is held, then the template with said dynamometer are pulled perpendicular to the sample; the tensile force is then measured and the surface condition of the sample noted.

The results obtained show that the tensile force to be applied to release the icicle is 17 N for the sample according to the invention and 57 N for the reference sample.

It is concluded that a screen 1 provided with a protective layer 4 according to the invention, which contains in particular polypropylene, which is an apolar and hydrophobic molecule, makes it possible to reduce the adhesion of ice to the surface.

In addition, the surface state of the sample according to the invention—in this case on the side of the protective layer 4—after the icicle has been torn off is unchanged, whereas that of the reference sample is degraded, with fibers being torn off.

The scrape test is performed as follows:
the test consists of rubbing a metal blade against a flat sample at a temperature of 23° C., perpendicular to the sample, and assessing the state of degradation; the blade is 2 mm wide and 17 mm long,
a 70×40 mm sample is subjected to a back-and-forth movement of the blade under a 7 kg load, with the blade making 50 round trips,
the surface state of the sample is then observed.

The results obtained show that the sample according to the invention shows no degradation, whereas the reference sample has been degraded.

The acoustic absorption test (FIG. 2) shows, surprisingly, that the absorption properties of the sample according to the invention are similar to those of the reference sample, and thus despite the presence of the protective layer 4, which might have been thought to act as a barrier to the penetration of acoustic waves into the screen 1.

Indeed, we can see that the presence of the protective layer 4 slightly improves the absorption performance of the screen 1 up to around 4000 Hz, and slightly degrades it above around 4000 Hz.

1. Sound protection screen (1) intended to be mounted under a motor vehicle, said screen comprising a thermo-compressed shell (2), said shell being based on structural fibres bonded together by a heat-activated bonding agent, said shell being provided with an outer face (3) intended to face the road, said screen being characterized in that:
it also includes a protective fibrous layer (4) covering said outer face,
the fibers constituting said layer are of two types distributed according to the following percentages by weight:
between 50% and 70% of bi-component fibers comprising a core with a high melting point and a sheath with a lower melting point, said sheath ensuring the bond between the fibers following its melting,
between 30% and 50% of polypropylene fibers, so as to present an apolar component conducive to low ice adhesion on said layer,
said layer has been melted at a temperature higher than the melting temperature of said sheath and polypropylene and lower than that of said core, so as to provide a surface state smoothened by said melting and to minimize the mechanical adhesion of ice on said layer.

2. Screen (1) according to claim 1, characterized in that its resistance to the passage of air is comprised between 250 and 8000 N·s·m⁻³.

3. Screen (1) according to claim 1, characterized in that the protective layer (4) is co-needled with the shell (2).

4. Screen (1) according to claim 1, characterized in that the bonding agent of the shell (2) is optionally formed:
of bi-component fibers whose sheath has been melted,
or of polypropylene fibers.

5. Screen (1) according to claim 1, characterized in that the shell (2) additionally comprises fine fibers with a titre of less than 3.5 dtex intended to improve sound absorption.

6. Method for producing a screen (1) according to claim 1, characterized in that it comprises the following steps:
provide a first fibrous web comprising structural fibers and a heat-activatable bonding agent,
provide a second fibrous web whose fibers are of two types distributed according to the following percentages by weight:
between 50% and 70% of bi-component fibers comprising a core with a high melting point and a sheath with a lower melting point, said sheath ensuring the bond between the fibers following its melting,
between 30% and 50% of polypropylene fibers,
superimpose said layers one on top of the other and compress the assembly between two platens heated to a temperature firstly higher than the melting temperature of said sheath and polypropylene and than the activation temperature of said bonding agent, and secondly lower than that of said core,
shape said assembly once heated in a cooled mold to give it the geometry of the screen to be obtained,
remove said screen.

7. Method according to the preceding claim, characterized in that it comprises an additional step of co-needling the fibrous webs together before they are compressed between the platens.
